(19) United States
(12) Patent Application Publication
(10) Pub. No.: US 2025/0272767 A1
(43) Pub. Date: Aug. 28, 2025

(54) GPU-BASED EDGE SERVER AND FARM MANAGEMENT PLATFORM FOR OPTIMIZED RESOURCE UTILIZATION AND WORKFLOW MANAGEMENT

(71) Applicant: Ryzee, Inc., San Diego, CA (US)

(72) Inventors: Ming Liu, San Diego, CA (US); Victor Liu, San Diego, CA (US); Lydia Ekeroth, San Diego, CA (US); Khang Pham, San Diego, CA (US); Jason Smith, Hopkinton, MA (US)

(73) Assignee: Ryzee, Inc., San Diego, CA (US)

(21) Appl. No.: 19/048,011

(22) Filed: Feb. 7, 2025

Related U.S. Application Data
(60) Provisional application No. 63/557,489, filed on Feb. 24, 2024.

(51) Int. Cl. G06Q 50/02; G06Q 10/0631; H04W 84/18

(52) U.S. Cl. CPC G06Q 50/02; G06Q 10/0631; H04W 84/18

(57) ABSTRACT

A platform for managing controlled environment agriculture farms provides hardware and software components with the principal component being an edge server. The edge server stores and processes local data, serves as a central node to a mesh network of IoT devices, and an entry point for the farm's data to be reached via internet. Secondary components include the IoT devices used for sensing and controls and a combination of mobile and web applications. These applications present utilization-based planning models that assist with tracking crops, assets, and tasks in a farm. In its entirety, the farm management platform is designed to increase and improve tracking of farm assets and traceability of food, reduce labor costs, and reduce costs to farmers.

### CROSS REFERENCE TO RELATED APPLICATIONS

This utility patent application claims priority back to U.S. Provisional Application No. 63/557,489, filed Feb. 24, 2024, the contents of which are incorporated by reference into this application.

### BACKGROUND

This disclosure is directed generally to the field of data storage and more specifically to an edge server that can store data locally rather than solely in a cloud. The invention is particularly suited for remote greenhouses and warehouses where internet connectivity via the cloud can be sporadic and problematic. In controlled environment agriculture (CEA), crop production moves at a faster pace with more moving parts than traditional soil-based agriculture, CEA farmers must manage the creation, transplantation, and harvesting of crops on asymmetrical timetables, which can lead to underutilized resources and waste. Current methods of management are time-consuming, arduous, and often customized, rendering them inapplicable to other operations.

The current invention is centered around an “edge server,” that can be deployed at a farm or a warehouse, allowing for more data to be stored locally and with redundancy, rather than solely in the cloud. An “edge server,” is a device that provides computer processing and access to a local network. Complex processing to develop and run machine learning models and artificial intelligence can, to a certain extent, be done on the edge server located at the farm. The invention's model to managing crops is called “Utilization-based Planning” (UBP), which has been crafted to give CEA farmers quick options for planning Crop Groups in complex, fast-paced growing operations.

Because many CEA farms are not installed with internet connectivity and/or are not located close enough to cell towers, cloud-dependent software is of limited use to them. One potentially competing business sells and deploys wireless sensors that communicate via Bluetooth wireless; a second business has wireless sensors measuring light, CO2, temperature, and humidity; and a third business deploys devices measuring temperature and relative humidity, communicating over sub-1G and Bluetooth Low-Energy (BLE®). None of these systems offer edge server capabilities. Each competitor listed depends heavily on the Cloud for data storage and processing if any. A means to plan for and manage a large number of crop cycles by means of defining, “crop groups,” and “harvest groups,” is unprecedented. Crop planning models offered by potential competitors to the novel invention are not as robust in terms of tracking features and asset definitions.

### BRIEF SUMMARY OF INVENTION

An enhanced method of planning and managing crops is disclosed. The invention is an integrated data-driven CEA Farm Management Platform (FMP) that combines advanced edge server technology, mobile applications, wireless mesh network, IoT sensors, data analytics, management, tracking, and automation. The invention will provide CEA farmers with real-time insights and intelligent controls, enabling them to optimize resource utilization, operational management, reduce waste, and increase crop yields and quality. The FMP is modular, scalable, and adaptable for different crop types, farm types, and farm sizes.

Utilization-Based Planning and Management (UBP) allows growers to look ahead in time, recognize what space and resources are available, and schedule seeding. For commercial growers, the need to harvest crops based on sales that do not clearly align with seeding patterns. UBP serves as a component in the FMP.

An edge-server based architecture supporting the Utilization-Based Management is also disclosed. For farms that do not have ready access to the internet, cloud-based software applications are not a viable option. For more complex management systems, simple mobile applications are not powerful enough. The inventors joined force to devise a network based around an edge server of their own design that can interface to IoT devices, mobile applications, and the internet.

Contents of the following disclosed are not limited to the contents of this summary. It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims are regarded by the inventors as their invention.

### BRIEF DESCRIPTION OF DRAWINGS

FIG. 1 is a diagram of edge server modules and interface.

FIG. 2 illustrates edge server's exterior views with ports and antenna.

FIG. 3 is a “Crop Group Ticket” screen showing information that is tracked through the cycle of a given Crop Group as well as relevant inputs and controls.

FIG. 4 is a “Harvest Group Ticket” screen with multiple Crop Groups being pulled from to form a single Harvest Group.

FIG. 5 is a “Crop Planning” screen displaying the inputs and controls for users to initiate seeding using the “Available Crop Group Search” function.

FIG. 6 is a “Crop Planning” screen displaying the inputs and controls for users to initiate seeding using the “Custom Group Creation” function.

FIG. 7 is a network diagram depicting the edge server, Tablet, and Web Portal.

### DETAILED DESCRIPTION OF DRAWINGS

As previously described, a Farm Management Platform (FMP) and Crop Planning Model is disclosed. FMP is composed of hardware and software components which are disclosed.

The edge server is a Graphics Processing Unit (GPU) based edge server that runs application software and data processing required for machine learning and AI. The edge server may connect to the internet via Ethernet or optional 4G(LTE)/5G. Additional connectivity includes Wi-Fi, Bluetooth Low Energy (BLE), and sub-1 GHz (primarily to interface with an IoT mesh network). Each edge server provides local storage with redundancy backup for safe and secure local farm and crop data storage.

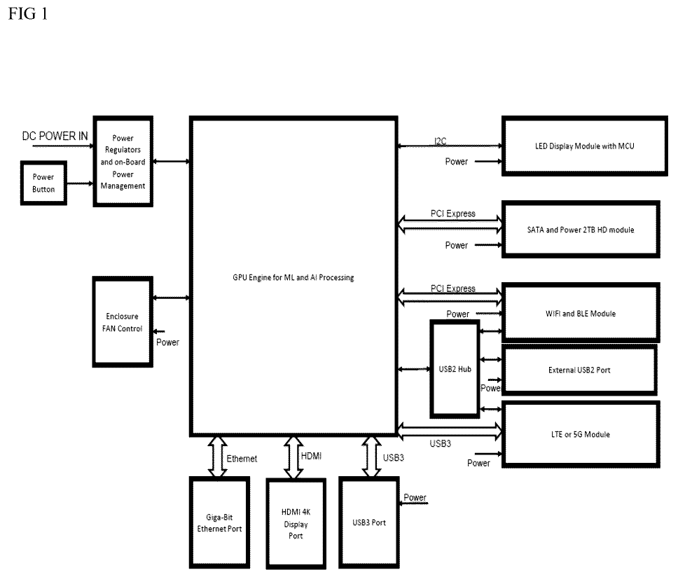

FIG. 1 is a diagram of the internal components of the edge server.

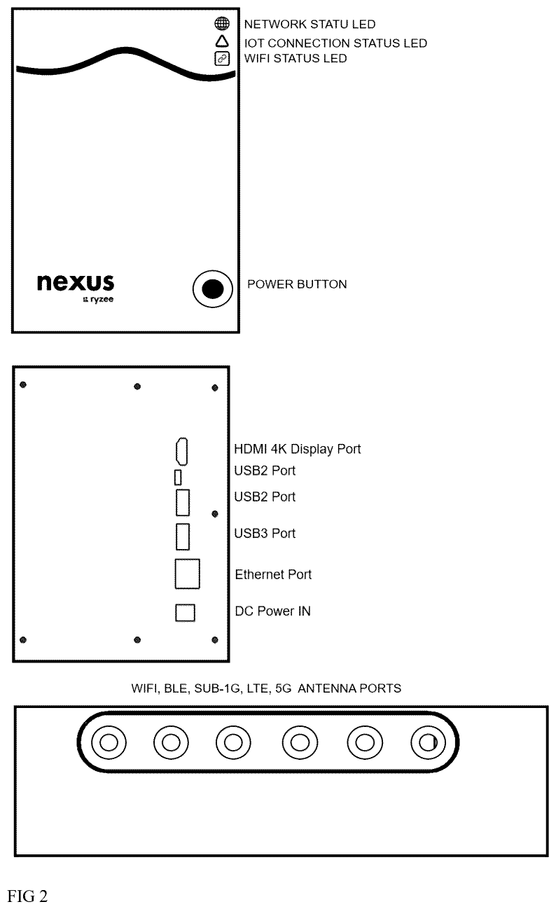

FIG. 2 is the exterior representation of the edge server with ports exposed.

The Utilization-Based Operation Optimization and Management Platform's (UBP) algorithms bring insights to farmers' hands via mobile application, allowing them to view, create, report issues on, and otherwise manage crops. The UBP consists of both user interface features and a variety of software components. Primary components of the UBP include but are not limited to (1) Asset Management, (2) Crop Group Management, (3) Harvest Group Management, (4) Discard Group Management, (5) Crop Recipes, (6) Crop Planning, RFID technology, and QR code technology.

“Asset Management,” a component of the UBP. The UPB algorithm is always trying to recognize and display gaps in underutilized resources, mainly defined as space in the farm. Assets are labeled with QR codes for quick data recall, and assignment of assets and crops. The Asset Management component of the UBP is composed of (1) site definition and (2) asset usage management.

“Site Definition,” changes from site to site due to varying sizes, technologies, crop types, and a variety of other factors. Each site may have three different crop stages, each with a unique sizing, crop capacity, location, and further sub-units. Current stages consist of, (1) “propagation,” initiated by a “seeding,” followed by (2) “nursery,” and ending with, (3) “finishing.” In hydroponics farms, during the propagation stage, crops are placed in “propagation trays,” of fixed unit sizes; during the nursery and finishing stages, crops are placed in channels, rafts, troughs, or other receptacles with fixed unit sizes. These units are all entered during edge server's setup and customization of the UBP for the new site.

“Asset Usage Management,” is the tracking of what assets are occupied by which crops at a given time. This data can be historical (retrospective), current, and projected. All of this data is used to manage the capacity and allow the user to maximize asset utilization in the farm (site).

A “Crop Group,” is defined as a group of plant crops (1) from the same seed lot, (2) planted at the same time, and (3) scheduled for transplants and harvests to happen at the same time. All of this can be planned for while traversing through different points in time to see what assets are available at a given moment, which is invaluable in fast-paced CEA farms. During seeding, RFID tags that follow a crop group through its crop cycle may be programmed. These RFID tags can bring up Crop Group information such as past, current, and future location; issues; actions; and other details. Crop Groups are attributed, (1) Crop Group Tickets, (2) Crop Group Issues, and (3) Crop Group Actions.

“Crop Group Tickets,” are how users reference information specific to a given Crop Group. Such information includes relevant issues, actions, location, and projectional data. From this page, users manage and log transplants (moving crop from one stage to the next);

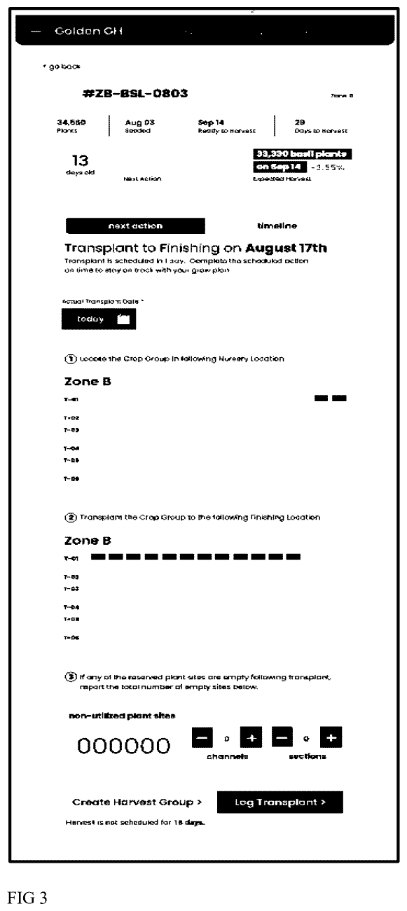

FIG. 3 displays the screen of a Crop Group Ticket. This page is referred to through the entirety of a crop cycle for reference.

“Crop Group Issues,” are a means of tracking issues such as pests, growth anomalies, and other issues related to a given Crop Group. These issues can be referenced for corrective and preventive action; and

“Crop Group Actions,” include initiating seedings on previously scheduled crop groups, transplanting (moving crops from one stage to the next in the greenhouse), and tasks to address the aforementioned issues. Preventive maintenance such as integrated pest management (IPM) can also be assigned to specific crop groups.

In addition to Crop Groups, the UBP employs “Harvest Groups,” which allow users to detach the management of the growth of crops from the fulfillment of orders. This distinction diminishes the challenge of selecting which crops to harvest when orders do not conform to the Crop Groups as discrete units. Harvest Groups are limited to one crop type (i.e. one seed type) but are not limited by other factors.

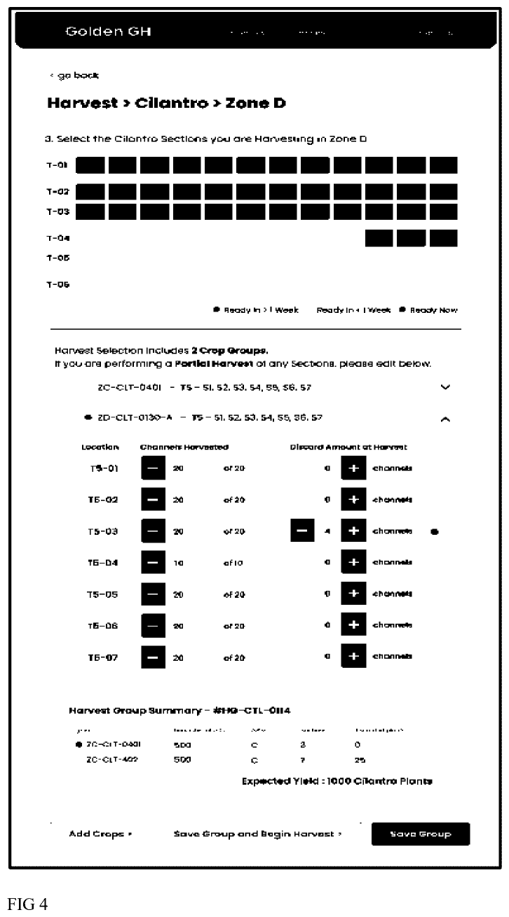

FIG. 4 is a screen indicating what a user must select when defining a new harvest group.

“Discard Groups,” allow users to clear sections of the farm using mechanisms similar to Harvest Groups. The discard flow is necessary to log what plants are leaving the farm without intention to sell. Data collected about discarded crops is to be used for yield reporting, yield projecting, loss mitigation strategizing, and efficiency calculations.

“Crop Recipes,” contain the information necessary for a Crop Group to be set up. Information found in a crop recipe includes, (1) seed type, (2) number of days in each stage (which are propagation, nursery, and finishing), (3) ideal pH levels, (4) ideal EC levels to account for nutrient mixtures, and (5) other environmental control factors.

“Crop Planning,” refers to the methods by which Crop Groups are generated in the UBP. The inventors have developed two methods of creating Crop Groups in Crop Planning; namely, “Available Group Search,” and “Custom Group Creation.” These features present the user with the core of the UBP. The UBP keeps track of what crops are in what locations of a greenhouse and at what time, referring to the Asset Management component for data and options to present to the user.

“Available Crop Group Search,” allows the user to enter fewer details and is geared towards users who wish to enter in less information and to be presented with options that fit general requirements. To search for available crop groups, the user must fill in the mandatory fields, which are (1) the crop type and (2) the number of days for the crop group to be in each stage. The user may fill out optional fields, which are (1) the target seed or harvest date, (2) the number of plants desired for the yield, and (3) which zone that the Crop Group shall occupy. The UBP runs a search on all the space available for the planned number of days and in each section that the crop group must occupy. Options displaying the maximum number of crops that can be planted given the entered parameters are presented to the user. The user may select any one of the options presented, which brings up the confirmation stage/page. On this page, the user can define exactly the number of crops that they wish to harvest up to the maximum total available.

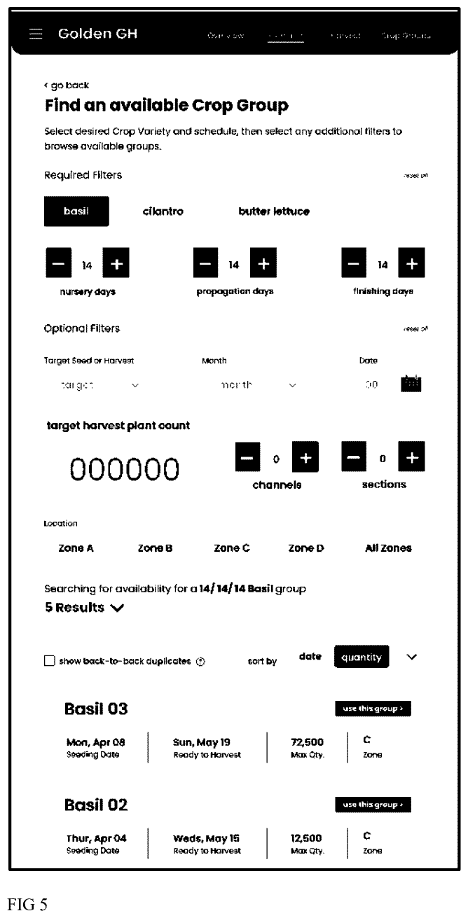

FIG. 5 is a screenshot of the “Available Group Search” screen. The screen shows the mandatory fields, optional fields, and two crop group options.

“Custom Group Creation,” gives the user fields of entry to plan seeding and allocate greenhouse space for each stage in the crop cycle. Initial information that a user must enter in custom crop group creation comprises (1) the crop type, (2) the number of days that the crop group is meant to occupy each stage, and (3) which zone the crop group shall occupy. The user may traverse through time and will be presented with a visual representation of what assets are available for the crop group. Increments of time are defined as (1) “day,” with each day traversal showing the user the asset usage at 11:59 pm, and (2) “event,” with each event being defined as a transplant or harvest. Once a desired point in time has been reached, the user may begin selecting the finishing assets that the crop group is being planned to occupy. Nursery and propagation assets will be automatically assigned based on the finishing assets chosen by the user.

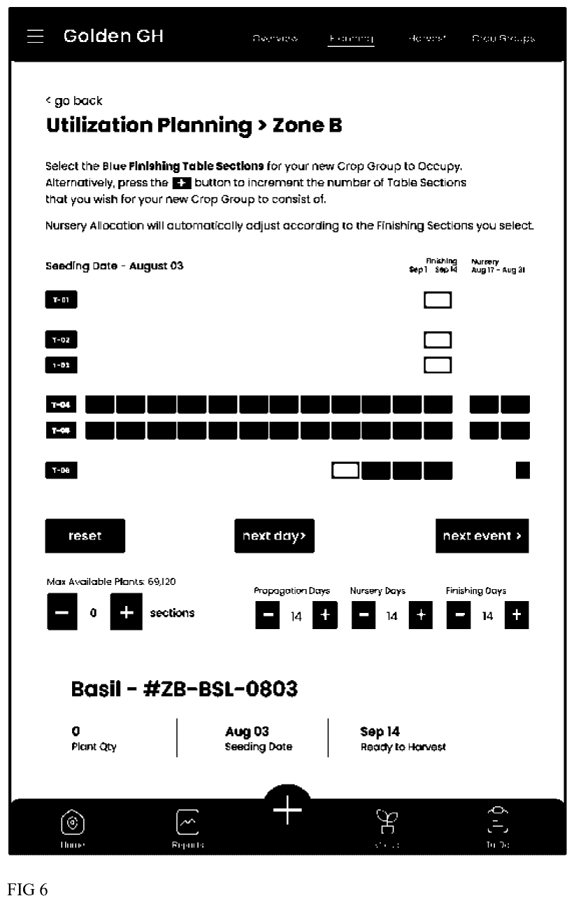

FIG. 6 is a crop planning screen displaying the fields available for users to enter. The selected zone is also displayed, which the user may interact with to add or subtract the number of sections that they wish for their new crop group to occupy.

The UBP system uses Radio Frequency Identification (RFID) technology for traceability at each stage of the crops from seeding to post-harvest. These tags refer to tables of information stored on the edge server that reduce overhead and labor associated with tracking and recording assets. The edge server resources are used for processing and storage of OnSite and Web Portal data. Weak-points in the farm operation are indicated by analyzing historical data with machine-learning models. Optimized utilization prevents over-planting to maintain maximum productivity, resulting in maximizing yields while using the fewest necessary resources. Inventory monitoring and reporting is facilitated with the use of RFID tags, which are scanned and read via the OnSite mobile application.

Quick-response (QR) code technology is used to track stationary assets such as hydroponics table sections as well as non-stationary assets such as harvested crop bins. The OnSite tablet application allows the user to scan QR codes and immediately see data relevant to the scanned asset.

The Farm Management Platform enables the UBP to run in an ecosystem of user interfaces, wireless sensors, cloud support, and other components, centered around the edge server. Below are components not of the Farm Management Platform that function adjacent to the UBP.

The Grower's Portal is a browser-based web portal that gives farmers and other users access to internet-connected edge server The Grower's Portal allows for live-view and management of any farm that a edge serveris installed at. This web portal is also how grower support is provided.

The OnSite application is a mobile Farm Management Software (FMS) application used by farmers to manage all farm operation and management activities. OnSite uses BLE (Bluetooth Low Energy) and Wi-Fi to communicate with the edge server for user log in, any asset updates, and synchronizations. BLE or a QR code is used to create user credentials for login via Wi-Fi.

IoT devices located in each farm connected via a sub-1 GHz wireless mesh network to communicate among each other for best-route connection to the edge server. These IoT nodes are also designed to communicate with the tablet (go into more detail). IoT devices include the environmental sensors, nutrient sensors, and Vision Systems. The environmental sensor device that gathers data on CO2, temperature, relative humidity, air pressure, and light. It is powered by a rechargeable battery and uses a solar cell for charging and light sensing. The nutrient sensor is a nutrient monitoring and dosing device for optimal CEA nutrient solution setting. IoT Vision Systems monitor plant growth, temperature, farm status, and gather other data critical to reducing labor associated with management of the farm.

The Cloud: The FMP utilizes cloud services with Amazon Web Services® (AWS), though the services may be ported to Google Cloud® or Microsoft Azure®. The Cloud provides services for remote access to each edge server; edge server-to-edge server communication; Web Portal access and hosting, and server applications for desktop web browser and mobile applications; user account management; and data storage.

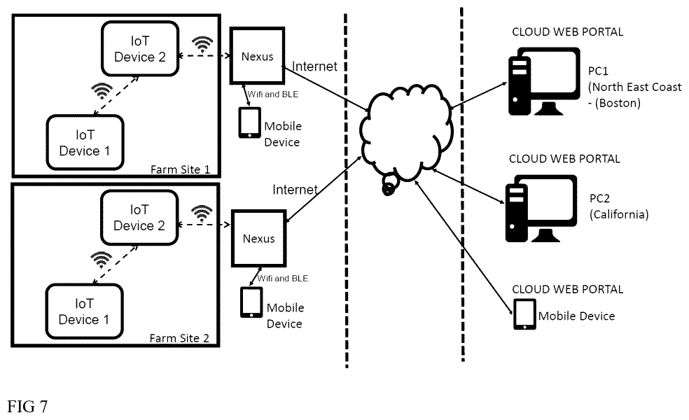

FIG. 7 is a diagram of the network architecture as defined by the edge server platform. The diagram demonstrates the central role played by the edge servers as they manage local networks while allowing for external connection.

Adoption of the FMP would require setup dependent on the farm configuration before deployment of hardware. Farm configuration includes the farming methods used, size of farm, number of and orientation of assets, and crop recipes. To program an edge server for deployment to a new farm, farmers will provide information about their farms to factory's programmers. This information may be provided via interview, on-site visitation/consulting, or wizard on web browser.

The Edge servers are ready to use, “out-of-the box,” as most of the system configuration is completed at production before shipment. Any IoT devices would be delivered similarly, pre-programmed to communicated over a secure network.

1. A device for greenhouse and warehouse management:
wherein the device comprises an edge server and a farm management platform.

2. The device of claim 1, wherein the edge server hosts a local mesh network of IoT devices and interfaces to one or more mobile devices and IoT devices at a given farm site;
wherein the farm management platform creates and manages one or more crop groups based on information received from the user via web browser or mobile application;
wherein the farm management platform creates one or more harvest groups based on the user's designation of one or more crops from one or more existing crop groups.

3. The device of claim 2, further comprising: wherein the device computes a tracking of crops in one or more groups as defined by a seed lot seeding date, one or more transplant dates, and a harvest maturity date.

4. The device of claim 3, further comprising: one or more RFID tags accompanying the one or more crop groups for ease of data recall and food safety information storage.

5. The device of claim 4, further comprising the tracking of the one or more crop groups as defined by their harvest groupings.

6. The device of claim 5, further comprising: wherein the device manages one or more assets of CEA farms or warehouses with one or more crop stages defined by a hardware configuration that one or more crops may occupy during a given stage.

7. The device of claim 6, wherein the device tracks asset usage over time, indicating capacity, and allowing form projected usage and availability for future crop groups.

8. The device of claim 7, wherein the device includes asset labeling with static QR codes for quick reference of assets' current status and histories.

9. A device for greenhouse and warehouse management:
wherein the device comprises an edge server and a farm management platform, wherein the edge server hosts a local mesh network of IoT devices and interfaces to one or more mobile devices and IoT devices at a given farm site.

10. The device of claim 9, further comprising: wherein the device computes a tracking of crops in one or more groups as defined by a seed lot seeding date, one or more transplant dates, and a harvest maturity date.

11. The device of claim 10, wherein the farm management platform creates and manages one or more crop groups based on information received from the user via web browser or mobile application.

12. The device of claim 11, wherein the farm management platform creates one or more harvest groups based on the user's designation of one or more crops from one or more existing crop groups.

13. The device of claim 12, further comprising the tracking of the one or more crop groups as defined by their harvest groupings.

14. The device of claim 13, further comprising: one or more RFID tags accompanying the one or more crop groups for ease of data recall and food safety information storage.

15. The device of claim 13, further comprising: wherein the device manages one or more assets of CEA farms or warehouses with one or more crop stages defined by a hardware configuration that one or more crops may occupy during a given stage, wherein the device tracks asset usage over time, indicating capacity, and allowing form projected usage and availability for future crop groups, wherein the device includes asset labeling with static QR codes for quick reference of assets' current status and histories.

16. The device of claim 13, wherein the device tracks asset usage over time, indicating capacity, and allowing form projected usage and availability for future crop groups.

17. The device of claim 16, wherein the device includes asset labeling with static QR codes for quick reference of assets' current status and histories.

18. A device for greenhouse and warehouse management:
wherein the device comprises an edge server and a farm management platform, wherein the edge server hosts a local mesh network of IoT devices and interfaces to one or more mobile devices and IoT devices at a given farm site;
wherein the farm management platform creates and manages one or more crop groups based on information received from the user via web browser or mobile application;
wherein the farm management platform creates one or more harvest groups based on the user's designation of one or more crops from one or more existing crop groups;
further comprising the tracking of the one or more crop groups as defined by their harvest groupings.

19. The device of claim 18, further comprising: wherein the device computes a tracking of crops in one or more groups as defined by a seed lot seeding date, one or more transplant dates, and a harvest maturity date, further comprising: one or more RFID tags accompanying the one or more crop groups for ease of data recall and food safety information storage, further comprising: wherein the device manages one or more assets of CEA farms or warehouses with one or more crop stages defined by a hardware configuration that one or more crops may occupy during a given stage.

20. The device of claim 19, wherein the device tracks asset usage over time, indicating capacity, and allowing form projected usage and availability for future crop groups, wherein the device includes asset labeling with static QR codes for quick reference of assets' current status and histories.
